(19) United States
(12) Patent Application Publication
(10) Pub. No.: US 2026/0296786 A1
(43) Pub. Date: Oct. 1, 2026

(54) INTERFACE UNIT FOR RECEIVING VARIOUS LOAD CARRIERS ON AN UNDERRIDE SHUTTLE

(71) Applicant: Jungheinrich Aktiengesellschaft, Hamburg (DE)

(72) Inventors: Florian Zeilhofer, München (DE); Sandrik Oberascher, München (DE); Martin Schöpp, Mering (DE); Linus Ferlinz, München (DE)

(73) Assignee: Jungheinrich Aktiengesellschaft, Hamburg (DE)

(21) Appl. No.: 19/477,945

(22) PCT Filed: Apr. 19, 2024
(86) PCT No.: PCT/EP2024/060683

§ 371 Date: Oct. 23, 2025

(30) Foreign Application Priority Data
Apr. 24, 2023 (EP) 23169391.2

(51) Int. Cl. B65G 1/04; B66F 9/075; B66F 9/18

(52) U.S. Cl. CPC B65G 1/0492; B66F 9/0755; B66F 9/18

(57) ABSTRACT

The present invention relates to an interface unit for receiving different load carriers, in particular pallets and mesh boxes, on an under-ride shuttle with a longitudinal axis and a transverse axis, comprising a substantially flat contact surface for placing a load carrier, at least one first sensor unit for detecting the presence of the load carrier, wherein the at least one first sensor unit is integrated with a stop element projecting from the contact surface, which is arranged to limit a displacement of the load carrier on the contact surface, wherein the at least one stop element and thus the corresponding first sensor unit can be mounted on the contact surface at at least two attachment positions, and at least one second sensor unit for detecting a correct reception and positioning of the load carrier.

The present invention relates to an interface unit for accommodating different load carriers, in particular pallets and mesh boxes of different dimensions, on an under-ride shuttle with a longitudinal and a transverse axis, and to an under-ride shuttle comprising such an interface unit mounted on its upper side.

In the context of the increasing automation of logistics facilities, so-called under-ride shuttles have recently gained increasing importance. These can transport loads autonomously or semi-autonomously on their upper side, such as different types of pallets or mesh boxes carrying goods on them or inside them. To pick up such loads, they are driven under by an under-ride shuttle in a transfer station and the corresponding loading surface on the top of the under-ride shuttle is raised until the load is lifted from the transfer station and carried on the under-ride shuttle, whereupon it can be transported to a designated location and transferred there again. For this purpose, such under-ride shuttles are usually set up for omnidirectional movement and their operation is coordinated and controlled through a control system. Since the loads to be transported by such under-ride shuttles can be considerable and sometimes exceed one ton in weight, it is essential to ensure that they are reliably supported on the top of such under-ride shuttles and secured against slipping and/or tipping, as the risk of accidents due to slipping loads or incorrect placement thereof is considerable and recovery of such a slipped load is extremely costly.

For these reasons, it may also be necessary to provide a sensor system for detecting the presence of a load or a load carrier on an interface unit mounted on the top of an under-ride shuttle in order to detect the presence and correct pick-up, positioning or alignment of a corresponding load carrier.

Although it is known from the prior art to provide individual interface units on the upper side of under-ride shuttles for transporting corresponding load carriers, in particular different types of pallets or mesh boxes, different interface units are usually required for different load carriers, since the shapes and dimensions of the interface units are tailored to the respective load carriers.

However, this reduces the flexibility of under-ride shuttles equipped with such interface units and it may be necessary, for example, when changing between two different types of load carriers during operation for such an under-ride shuttle, to first remove the corresponding interface unit from the top of the under-ride shuttle in order to then be able to remount another interface unit adapted to the new type of load carrier. This individualization of individual interface units and their tailoring to specific types of load carriers is also reflected in the respective positioning of the above-mentioned sensor units for detecting the presence and alignment of the load carriers on the interface units, as these must also be individually adapted to the individual types of load carriers, each of which requires different sensing points due to different geometric properties.

Accordingly, it is the task of the present invention to provide an interface unit which as it is typical for its kind, on the one hand, is capable of carrying different types of load carriers in order to increase the flexibility of the under-ride shuttle equipped with it and, on the other hand, is equipped with a sensor system such that all types of load carriers that can be accommodated can be reliably detected with regard to their presence and their correct accommodation and positioning.

For this purpose and for solving the above-mentioned task, an interface unit according to the invention for receiving different load carriers, in particular pallets and mesh boxes of different dimensions, on an under-ride shuttle with a longitudinal and a transverse direction comprises a substantially flat contact surface for placing a load carrier, at least one first sensor unit provided at an attachment position for detecting the presence of the load carrier, and at least one second sensor unit provided at a second attachment position for detecting correct reception and positioning of the load carrier.

Accordingly, the provision of the flat contact surface makes it possible to place different types of load carriers and in particular pallets and pallet cages on the corresponding interface unit, whereby accordingly it may only be necessary to convert or reconfigure the at least one first and/or at least one second sensor unit in order to adapt them to corresponding types of load carriers with regard to their respective mounting and/or detection positions, without it being necessary to replace the entire interface unit on the under-ride shuttle.

The interface unit should be dimensioned in such a way that the largest load carrier it can accommodate can still be transported, which automatically results in sufficient contact area for correspondingly smaller load carriers. In particular, depending on the dimensions of the corresponding types of load carriers and the arrangement of the mounting points of the sensor units, transverse or longitudinal transportation of the corresponding load carriers on the under-ride shuttle can also be provided. It is of course possible to provide several first and/or second sensor units in order to be able to alternatively determine different widths of load carriers to be picked up, whereby different types of Euro pallets or other standardized pallets as well as mesh boxes according to DIN 15155 can be provided as corresponding load carriers.

In one embodiment of an interface unit according to the invention, the first sensor unit can be attachable to at least two first attachment positions and/or the second sensor unit can be attachable to at least two second attachment positions, wherein in particular two second sensor units can be provided, each of which can be mounted on two second attachment positions. This improves the adaptability of the interface unit to different load carrier dimensions and ensures correct detection.

According to the invention, the at least one first sensor unit can be integrated with a stop element projecting from the contact surface, which is set up to limit a displacement of the load carrier on the contact surface, wherein the at least one stop element and thus the first sensor unit can be mounted on at least two attachment positions on the contact surface.

Alternatively or additionally, a plurality of recesses can be provided in the contact surface, whereby the at least one second sensor unit can be operated in at least two configurations with respect to the contact surface in such a way that it detects the load carrier through one of the plurality of recesses. Here, the at least two configurations of the second sensor unit can be particularly suitable for enabling the correct recording of load carriers of different dimensions.

In this context, it should also be mentioned that different approaches can be taken with regard to the design of the at least one second sensor unit. For example, each of the plurality of recesses could be assigned to its own second sensor unit, whereby, depending on the load carrier to be transported, detection could then be carried out by only one or a few of these several second sensor units. Alternatively, the at least one second sensor unit could also be repositioned when changing between different load carriers, so that it could now carry out its detection through a suitable one of the recesses. It would also be conceivable to design a single second sensor unit in such a way that it can be operated in different configurations, i.e. in particular it could carry out its detection through different recesses depending on the configuration. This could be achieved, for example, by means of suitable switchable optical elements in the case of a light barrier. Although a certain amount of assembly and/or construction work is required in each of these embodiments, this is in any case still less than a complete replacement of the entire interface unit when switching to a different type of load carrier during operation of the corresponding vehicle.

In any case, the plurality of recesses in connection with the at least one second sensor unit can be designed as slots, in particular as slots running parallel to each other, which can then be adapted to the different types of load carriers to be transported with regard to their relative positioning on the contact surface, in particular to the respective width of the load carriers or the distance of elements to be detected on them in the case of a transverse transport thereof.

Furthermore, the at least one second sensor unit can be arranged in such a way that its detection area extends obliquely upwards, which is easy to realize, especially in the embodiment with slot-shaped recesses mentioned above, with regard to sufficient mounting tolerance. Such an arrangement is particularly advantageous when transporting plastic pallets with an open honeycomb structure, as reliable detection could not be guaranteed in such a case with a vertical arrangement. Furthermore, arranging the at least one second sensor unit at an angle prevents it from becoming easily soiled.

Furthermore, in order to produce redundancy, the interface unit according to the invention can comprise at least two second sensor units and at least two groups of recesses, wherein at least one of the second sensor units is assigned to each of the groups and the groups are preferably arranged symmetrically with respect to the longitudinal and/or transverse axis of the interface unit or a center point of the contact surface. In this way, a correct pick-up and positioning of the load carrier can be detected at opposite positions, making the detection more reliable. In this way, it is also possible to detect not only the presence of an object, for example a pallet board at a certain position, but also the presence of two objects, for example pallet boards at a defined distance from the second sensor units, whereby this distance can be characteristic of a certain type of load carrier.

Alternatively or additionally, the interface unit according to the invention may further comprise at least two first sensor units and at least two groups of attachment positions, wherein the groups of attachment positions are preferably arranged symmetrically with respect to the longitudinal or transverse axis of the interface unit or a center point of the contact surface. This measure also allows the presence of the load carrier to be detected with increased reliability.

In particular, in interface units according to the invention, the attachment positions can be designed as screw-on points which allow the stop elements to be screwed in. Here, for example, threaded holes with an internal thread can be considered, which allow stop elements provided with an external thread to be screwed in, in which the corresponding first sensor units are integrated accordingly.

In particular, the at least one first sensor unit and/or the at least one second sensor unit can be designed as a distance sensor or light barrier, each of which can easily and reliably detect the presence of the load carrier and its correct pick-up and positioning.

In order to provide a further measure in addition to the stop elements to prevent load carriers held on the interface unit from slipping, the upper side of the contact surface can be provided with a coating to increase friction, in particular a grip tape. This can prevent the load from slipping, especially during acceleration, braking and cornering, even if the corresponding load carrier is not yet in contact with the stop elements.

Alternatively or additionally, the interface unit according to the invention may further comprise at least one further stop element to which no sensor unit is assigned, so that the corresponding stop element serves only to secure the load on the top of the interface unit in its intended position. In any case, the corresponding attachment positions can be positioned on the contact surface in such a way that for each type of load carrier to be transported, a positioning of the stop elements and possibly further stop elements is possible in each case, which leaves a clearance for a movement thereof of, for example, 25 mm or less.

According to a further aspect, the present invention relates to an under-ride shuttle comprising an interface unit of the type just described mounted on its upper side, wherein a central control unit of the under-ride shuttle can be operatively coupled to the first and second sensor units of the interface unit.

Accordingly, if one of the sensor units detects that, contrary to expectations, no load carrier is present on the top of the interface unit and is detected or a corresponding load carrier is not correctly picked up and/or positioned, the corresponding central control unit of the under-ride shuttle could, for example, issue a warning to a control system or a human operator or even immediately shut down the under-ride shuttle in order to be able to rule out accidents or the like from the outset.

Further features and advantages of the present invention will become even clearer from the following description of an embodiment thereof, when considered together with the accompanying figures. These show in detail:

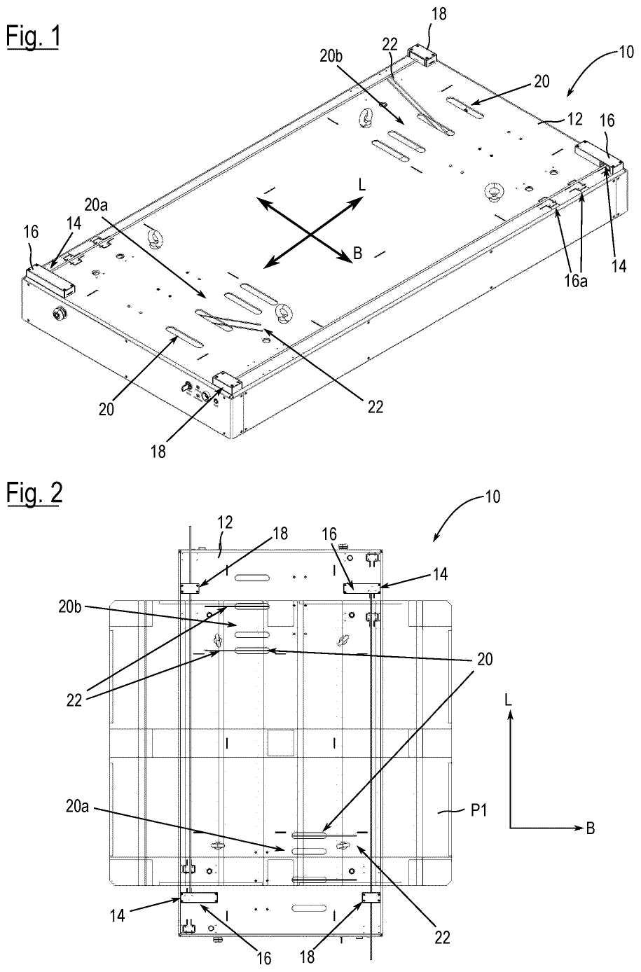

FIG. 1 isometric view of an interface unit according to the invention;

FIG. 2 schematic top view of the interface unit of FIG. 1 when carrying the first type of load carrier; and

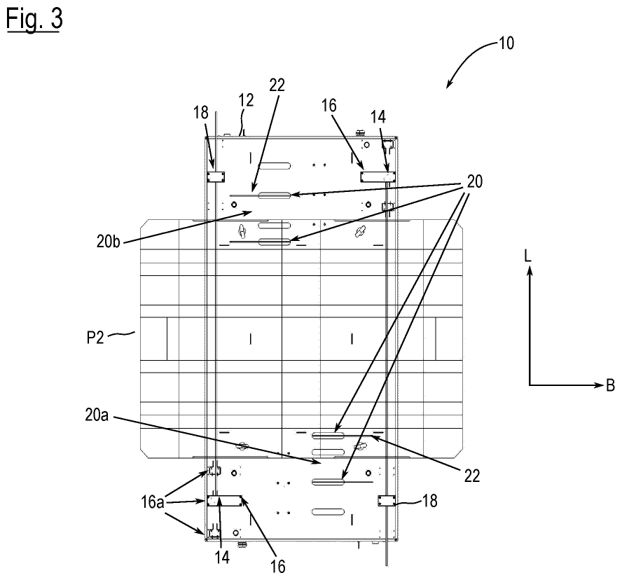

FIG. 3 view analogous to FIG. 2 when carrying a second type of load carrier.

FIG. 1 first shows an isometric view of an interface unit according to the invention for accommodating load carriers on an under-ride shuttle and is generally designated by the reference sign 10. The interface unit 10 has a longitudinal direction L and a transverse direction B, whereby the longitudinal direction L corresponds to the main direction of travel of the under-ride shuttle not shown in the figure, on the upper side of which the interface unit can be mounted by means of attachment sections that are also not shown.

Here, the interface unit 10 also comprises a substantially flat contact surface 12 on its upper side for setting up various types of load carriers, as will be explained below with reference to FIGS. 2 and 3.

Furthermore, two first sensor units 14 are provided diagonally opposite each other in the transverse direction B and longitudinal direction L for detecting the presence of a load carrier, which in the embodiment shown here can be designed as light barriers or distance sensors, with the corresponding detection area extending essentially parallel to the upper side of the contact surface 12, so that a load carrier resting on the contact surface 12 is reliably detected.

The first sensor units 14 are integrated in stop elements 16, which can be mounted on the upper side of the flat contact surface 12 at various attachment positions 16a and which, in a state in which a load carrier rests on the contact surface 12, also form an abutment for this in the longitudinal direction L in order to prevent it from slipping. Furthermore, in the embodiment shown here, two further stop elements 18 are shown, to each of which no first sensor is assigned, but which can also form a support for a corresponding load carrier in the event of slippage and thus, together with the two stop elements 16 in their arrangement in respective corners of the contact surface 12, define a receiving area for the corresponding load carrier. Furthermore, if the first sensor units 14 are designed as light barriers, associated reflectors can be integrated in the further stop elements 18.

Furthermore, two essentially similarly constructed pluralities of recesses 20a and 20b are provided in the contact surface 12, which are each formed by slots 20 extending in the transverse direction B of the contact surface 12. Here, the corresponding slots 20 of the two groups 20a and 20b are arranged in the upper side of the contact surface 12 in such a way that respective second sensor units 22 can detect correct pick-up and positioning of different types of load carriers through them. Since the second sensor units 22 are arranged below the upper side of the contact surface 12 for this purpose, the reference sign 22 in FIG. 1 merely indicates the detection areas of the corresponding sensor units.

FIGS. 2 and 3 now show how two different types of load carriers can be accommodated on the interface unit 10, each of which is positioned in the transverse direction B of the load carrier. FIG. 2 shows a wider pallet P1, for example a Euro pallet type 2, while FIG. 3 shows a narrower pallet P2, for example a Euro pallet type 1.

Since the first sensor units 14 already described above each cover a sensor area which extends essentially in the longitudinal direction L along the two opposite edges in the transverse direction B parallel to the upper side of the contact surface 12, it is possible to detect the presence of the corresponding load carrier P1 or P2 in both cases from FIGS. 2 and 3 with the same configuration. It should also be noted here that the provision of the multiple attachment positions 16a on the upper side of the contact surface 12 could allow further adaptation to load carriers of different widths in order to further limit the range of movement of the corresponding load carrier, for example to a maximum of 25 mm. The same applies to the other stop elements 18, which themselves do not comprise a sensor unit, but which restrict an area of possible slippage of the corresponding load carrier in a similar way to the stop elements 16 equipped with a first sensor and can also comprise reflectors in the manner already mentioned above, provided that the first sensors 14 in the opposing stop elements 16 are designed as light barriers.

Furthermore, it can be seen in FIGS. 2 and 3 that by a corresponding provision of second sensor units 22 at two positions of each of the two groups 20a and 20b of recesses in the upper side of the contact surface 12, both types of load carriers P1 and P2 can also be reliably detected with regard to their correct reception and positioning, since parts of the load carriers P1 and P2 are present in the corresponding detection areas. Accordingly, the positioning of the recesses 20 adapted to the different load carriers P1 and P2 to be transported ensures that the configuration of an interface unit 10 according to the invention shown in FIGS. 1 to 3 enables the alternative transportation of the two types of load carriers P1 and P2 without modification of the interface unit 10 or conversion of the corresponding under-ride shuttle and only a corresponding adaptation of the sensor units 14 and 22 may be necessary.

It should also be noted that the evaluation of two second sensor units allows conclusions to be drawn not only about the redundancy but also about the dimensions of the load carrier recorded, so that the load carriers of different dimensions recorded in FIGS. 2 and 3 can be distinguished. On the other hand, such a distinction would be much more difficult when evaluating a single second sensor unit and difficult to distinguish from situations in which a mere slippage could lead to a comparable detection situation of the second sensor units. For example, a slipping of the pallet P2 in the direction L in FIG. 3 could also lead to a detection in the area of the sensor unit 22 shown further up in the figure, so that the pallets P1 and P2 could not be easily distinguished only by evaluating this sensor unit.

1. Interface unit for receiving different load carriers, in particular pallets and mesh boxes of different dimensions, on an under-ride shuttle with a longitudinal axis and a transverse axis, comprising:
a substantially flat contact surface for supporting a load carrier;
at least one first sensor unit provided at a first mounting position for detecting the presence of the load carrier; and
at least one second sensor unit provided at a second attachment position for detecting a correct reception and positioning of the load carrier.

2. Interface unit according to claim 1, wherein the first sensor unit can be mounted on at least two first attachment positions and/or the second sensor unit can be mounted on at least two second attachment positions, in particular two second sensor units are provided, each of which can be mounted on two second attachment positions.

3. Interface unit according to claim 1, wherein the at least one first sensor unit is integrated with a stop element projecting from the contact surface, which is arranged to limit a displacement of the load carrier on the contact surface, wherein the at least one stop element and thus the corresponding first sensor unit can be mounted on the contact surface at at least two first attachment positions.

4. Interface unit according to claim 1,
wherein a plurality of recesses are provided in the contact surface, wherein the at least one second sensor unit can be operated in at least two configurations with respect to the contact surface in such a way that its detection of the load carrier takes place through one of the plurality of recesses.

5. Interface unit according to claim 4, wherein the plurality of recesses are formed as slots, in particular as slots running parallel to one another.

6. Interface unit according to claim 1, wherein the at least one second sensor unit is arranged such that its detection range extends obliquely upwards.

7. Interface unit according to claim 1, comprising at least two second sensor units and at least two groups of recesses, wherein at least one of the second sensor units is assigned to each of the groups and the groups are preferably arranged symmetrically with respect to the longitudinal axis and/or transverse axis of the interface unit or a center point of the contact surface.

8. Interface unit according to claim 1, comprising at least two first sensor units and at least two groups of mounting positions, wherein the groups of mounting positions are preferably arranged symmetrically with respect to the longitudinal axis and/or transverse axis of the interface unit or a center point of the contact surface.

9. Interface unit according to claim 1, wherein the attachment positions are designed as screw-on points which allow the stop elements to be screwed in.

10. Interface unit according to claim 1, wherein the at least one first sensor unit and/or the at least one second sensor unit is designed as a distance sensor or light barrier.

11. Interface unit according to claim 1, wherein the contact surface is provided on its upper side with a coating for increasing the friction, in particular a grip tape.

12. Interface unit according to claim 1, further comprising at least one further stop element to which no sensor unit is assigned.

13. Under-ride shuttle comprising an interface unit mounted on its upper side according to claim 1.

14. Under-ride shuttle according to claim 13,
wherein a central control unit of the under-ride shuttle is operatively coupled to the first and second sensor units of the interface unit.
